(19) United States
(12) Patent Application Publication
(10) Pub. No.: US 2017/0361544 A1
(43) Pub. Date: Dec. 21, 2017

(54) METHOD FOR PRODUCING A PART BY ADDING MATERIAL

(71) Applicant: Compagnie Plastic Omnium, Lyon (FR)

(72) Inventor: Jean-Luc THOMAS, Meximieux (FR)

(73) Assignee: Compagnie Plastic Omnium, Lyon (FR)

(21) Appl. No.: 15/534,575

(22) PCT Filed: Dec. 9, 2015
(86) PCT No.: PCT/FR2015/053396

§ 371 Date: Jun. 9, 2017

(30) Foreign Application Priority Data
Dec. 12, 2014 (FR) 1462347

(51) Int. Cl. B29C 69/02; B29C 64/106; B33Y 10/00; B29K 101/12; B29K 705/00; B29L 31/30

(52) U.S. Cl. CPC B29C 69/02; B29C 64/106; B33Y 10/00; B29K 2705/00; B29L 2031/3044; B29K 2101/12

(57) ABSTRACT

The invention relates to a method for producing a part made of plastic material for a motor vehicle, said part comprising at least one first section to which at least one second section is applied, in which the first section is produced. The second section of the part made of plastic material is produced by three-dimensional printing directly onto the first section of the part.

### FIELD OF THE INVENTION

The invention relates to a method for producing parts made of plastic material for a motor vehicle, such as exterior or interior bodywork parts.

### BACKGROUND OF THE INVENTION

In a known manner, a motor vehicle part made of plastic material is produced by molding. It may then undergo surface treatment and be stored.

Depending on the functions of this part, it may be necessary to add reinforcement elements so that it does not deform. Functional elements may also be added, such as elements to attach the part to the vehicle structure, elements to attach cables of electronic sensors and detectors and other plastic decorative parts. These elements are generally molded separately and stored.

The elements are then applied, for example, using clips, by bonding or by welding on the parts, depending on the requirements of each customer.

Thus, a large number of parts and various elements are stored, referenced and handled in order to meet the request of a customer.

### OBJECT AND SUMMARY OF THE INVENTION

The invention aims in particular to simplify the method for producing motor vehicle parts, especially by simplifying the storage and handling of the elements applied thereto.

To this end, the invention relates to a method for producing a part made of plastic material for a motor vehicle, said part comprising at least one first section to which at least one second section is applied, in which the first section is produced, wherein the second section of the part made of plastic material is produced by three-dimensional printing directly on the first section of the part.

Thus, since the method can be used to produce the second section of the part directly on the first section of the part, all the operations related to storage of the second section, i.e. storage, referencing and handling, are avoided.

Thus, the second section does not need to be attached by bonding, welding or clipping to the first section. There is therefore no need to provide for additional assembly steps.

Since the second section is produced by three-dimensional printing, the structure of the second section can be modified very easily. It can be adapted according to the options selected by the customer. This method therefore offers considerable flexibility in the geometry and number of parts applied to the first section of the part.

Thus, for parts produced in limited numbers, this method avoids the fixed costs associated with the production of a specific mold for each section to be applied to the first section of the part in order to meet the part customization requests expressed by a customer.

Using this method, it is also possible to consider producing spare parts without having to keep all the molds to produce each section of the plastic part.

The production method and the part obtained using this method may further comprise one or more of the following characteristics, taken alone or in combination.

Advantageously, the first section of the part comprises at least one area for mechanically attaching the second section to the first section. Since the first and second sections of the part are attached together mechanically, it is possible to apply a second section whose plastic material is different from the plastic material of the first section. This therefore avoids the problems associated with the compatibility of the materials of the two sections, which may therefore be of different types.

Preferably, the mechanical attachment area comprises a three-dimensional network of ribs. The second section of the part is therefore blocked in at least two directions. This three-dimensional network of ribs can be relatively complex and the insertion of the first section of the part into the second section of the part during its three dimensional-printing also blocks the two sections relative to each other in the third direction.

The first section of the part could also comprises at least two attachment areas, each attachment area defining a surface and a normal to this surface, the two normals not being parallel to each other. Thus, the blocking of the second section of the part relative to the first section is increased in the third direction for each attachment area.

Furthermore, the second section of the part may comprise a functional element and/or a reinforcement element. It is therefore possible to increase the mechanical resistance of the part to deformation over some of its surface or locally, as required, and/or provide functional elements such as elements used to attach the part to the vehicle structure or elements used to attach cables, sensors and other decorative or style components such a painted or chromium-plated trim, for example.

Advantageously, to produce the first section of the part, the method comprises the following steps:
producing at least one metal block having a three-dimensional network of ribs which are complementary to the ribs of the three-dimensional network of the first section,
placing the metal block in a mold at the location of the first section where the three-dimensional network is to be created,
molding the first section of the part.

This allows a mold to be customized according to the attachment areas required on the first section of the part. Thus, with the same mold, it would be possible to have several metal blocks and produce, depending on the metal blocks placed in the mold, a wide variety of first sections of the part. The three-dimensional network of ribs which are complementary to the ribs of the network of the first section of the metal block can be obtained by spark erosion or by three-dimensional printing of metal powder.

Preferably, the material of the first section of the part comprises polypropylene, polyamide, acrylonitrile butadiene styrene, polystyrene-b-poly(ethylene-butylene)-b-polystyrene, alone or mixed.

Furthermore, the material of the second section of the part comprises polypropylene, polyamide, acrylonitrile butadiene styrene, polystyrene-b-poly(ethylene-butylene)-b-polystyrene, alone or mixed.

The production method may also comprise a step, before producing the second section by three-dimensional printing, in which surface treatment is applied to the first section of the part. Thus, the first section of the part can be stored after receiving surface treatment. The types of surface treatment include, for example, steps of painting or chromium-plating the first section of the part. The surface treatment also comprises the steps required to make the paint, chromium-plating or other surface treatment adhere to the first section of the part.

The plastic part may be a bodywork part. A bodywork part means either an exterior bodywork part or an interior bodywork part. By way of non-limiting example, a bodywork part can be a front or rear bumper skin, a rocker box, a door, a boot door, a roof or boot spoiler, a wing, interior trim parts of the motor vehicle.

### BRIEF DESCRIPTION OF THE DRAWINGS

We will now describe several embodiments of the invention given as non-limiting examples in reference to the drawings, on which:

FIG. 1 is a cross-sectional view of a first part made of plastic material obtained by the method of the invention;

FIG. 2 is a larger-scale view of a detail of FIG. 1 showing a cross-sectional view of a three-dimensional network of ribs;

FIGS. 3 to 5 are top views of three examples of three-dimensional networks of ribs;

FIG. 6 is a diagrammatic view of a mold for producing the first section of the part according to the method of the invention;

FIG. 7 is a cross-sectional view of a second part made of plastic material obtained by the method of the invention;

FIG. 8 is a partial perspective view of a third part made of plastic material obtained by the method of the invention.

### MORE DETAILED DESCRIPTION

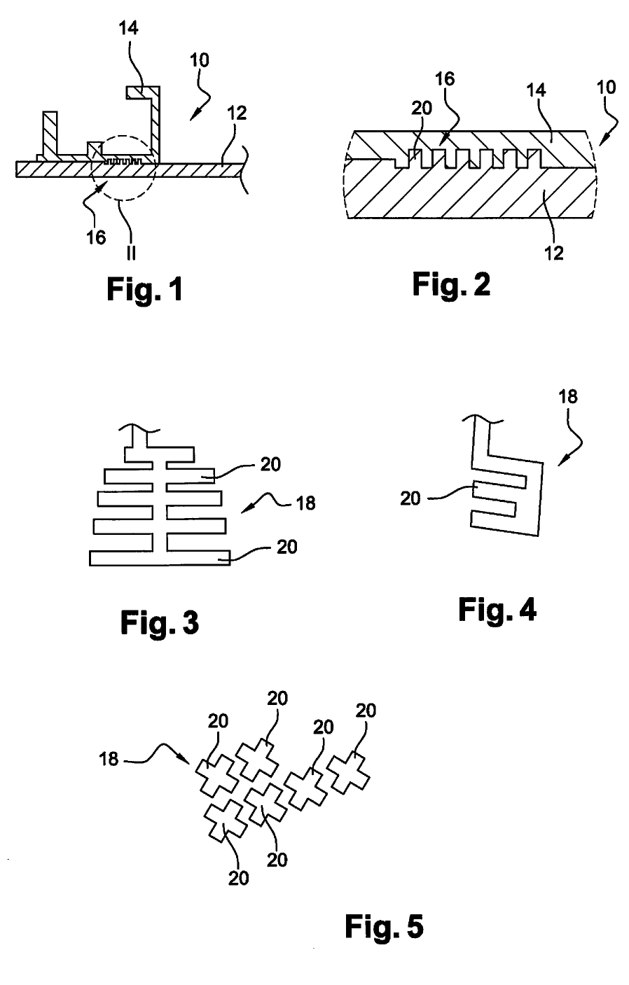

FIG. 1 shows a cross-sectional view of a part 10 made of plastic material for a motor vehicle obtained by the method of the invention.

This part 10 comprises a first section 12 to which at least one second section 14 is applied. These two sections are made of plastic material.

The first section comprises an area 16 for mechanically attaching the second section 14 to the first section 12.

The second section 14 of the part 10 can act as mechanical reinforcement for the first section 12 of the part. It can also be used to attach other elements to the part 10 and/or to attach the part 10 to the motor vehicle.

As can be seen on FIG. 2 which is a larger-scale view of the mechanical attachment area 16 of FIG. 1 and on FIGS. 3 to 5, the mechanical attachment area 16 comprises a three-dimensional network 18 of ribs 20.

FIGS. 3 to 6 show different embodiments of the three-dimensional network 18. In these top views, we see that the three-dimensional network 18 may take various forms.

The ribs 20 may be arranged together so as to form a continuous network of ribs 20 having, for example, a plurality of ribs 20 parallel to each other and connected to each other by other ribs 20, as shown on FIGS. 3 and 4.

The three-dimensional network 18 may also be formed by ribs 20 which form crosses in pairs, the crosses being distributed over the attachment area 16, as shown on FIG. 5.

We will now describe the method for producing the part 10.

The part 10 made of plastic material is obtained by producing the first section 12 by molding and then by printing the second section 14 directly on the first section 12 using the three-dimensional printing technique.

Advantageously, mechanical attachment areas 16 can be provided on the first section 12.

These mechanical attachment areas 16 may be materialized on the first section 12 by three-dimensional networks 18 of ribs 20. These three-dimensional networks 18 are obtained by the presence, in a mold 22 for producing the first part 12, of areas having a three-dimensional network 24 of ribs 26 which are complementary to the ribs 20 of the three-dimensional network 18 of the first section 12.

Preferably, these areas having a three-dimensional network 24 of ribs 26 are formed on a metal block 28 applied in a section 30 of the mold 22 for producing the first section 12.

Thus, depending on the number of metal blocks 28 present in the mold 22 and the presence or absence of an area 24 having a three-dimensional network of ribs 26 on these metal blocks 28, it is possible to produce in the same mold 22 first sections 12 of a part 10 having mechanical attachment areas 16 arranged at different locations on the first section 12 and/or having different three-dimensional networks 18 of ribs 20.

Thus, by replacing the metal block 28 by another metal block not provided with an area 24 having a three-dimensional network of ribs 26, a first section 12 is obtained which, in the area of this metal block, does not have a three-dimensional network 18 of ribs 20.

Furthermore, three-dimensional printing of the second section 14 on the first section 12 can be carried out after a step of surface treatment of the first section, for example by applying one or more coats to make a paint adhere to the first section 12 and by applying a coat of paint or chromium-plating.

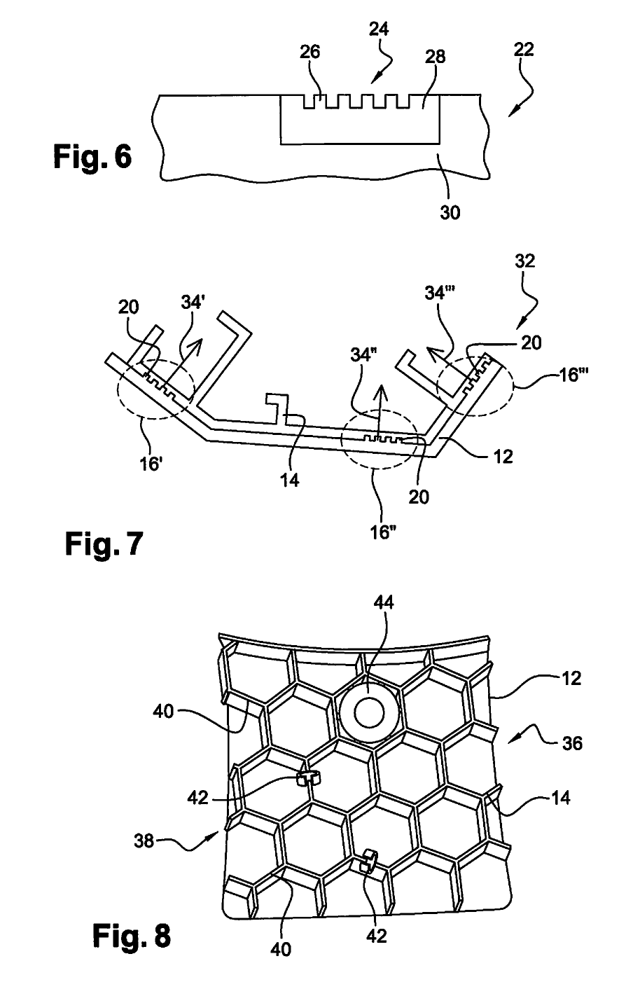

FIG. 7 shows a diagrammatic cross-sectional view of a bodywork part for motor vehicle, for example a bumper skin 32. Note that this bumper skin 32 is not flat. Typically, this bumper skin 32 has a thickness of a few millimeters, while it may have a length of over one meter. Also, the bumper skin 32 comprises a first “appearance” section 12, which is visible from outside the vehicle and a second section 14 used to reinforce the first section 12 to prevent in particular the bumper skin 32 from deforming and denting if pressure is exerted on it. The second section 14 may also comprise functional elements used to attach the bumper skin to the vehicle or to attach other elements to the bumper skin, such as park distance control (PDC) sensors which assess the distance to an obstacle located in the sensor's field of view like a camera or a radar.

In this cross-sectional view, the first section 12 comprises three mechanical attachment areas 16′, 16″ and 16′″ each having a three-dimensional network 18 of ribs 20. Each attachment area 16′, 16″, 16″ defines a surface and a normal 34′, 34″, 34′″ to this surface. The normals 34′, 34″, 34′″ are not parallel to each other in pairs.

Since at least two of the normals 34′, 34″, 34′″ are not parallel to each other, the second section 14 cannot be removed from the first section 12.

FIG. 8 shows a partial perspective view of a bodywork part 36 for a motor vehicle. This part 36 comprises a skin made of plastic material forming the first section 12 of the part 36 and a second section 14 having a continuous three-dimensional network 38 of ribs 40 forming a honeycomb which mechanically strengthens the skin, and therefore the first section 12. As can be seen on FIG. 8, ribs 40 are fitted with clips 42 in order, for example, to attach cables to the part 36 or to attach the part 36 to the motor vehicle.

The second section 14 of the part 36 also comprises another functional element 44 arranged between ribs 40 and attached to these ribs. This element 44 locally strengthens the first section 12 of the part 36 and acts as a means of attaching another element (not shown) to the part 36.

Obviously, numerous modifications can be made without leaving the scope of the invention.

1. A method for producing a part made of plastic material for a motor vehicle and including at least one first section and at least one second section, the method comprising:
applying the at least one second section to the at least one first section, wherein the at least one first section is produced,
producing the at least one second section by three-dimensional printing directly on the at least one first section, wherein the at least one first section includes at least one mechanical attachment area for mechanically attaching the at least one second section to the at least one first section.

2. The method according to claim 1, wherein the at least one mechanical attachment area comprises a three-dimensional network of ribs.

3. The method according to claim 1, wherein the at least one first section comprises at least two attachment areas, each attachment area defining a surface, a normal direction to the surface of each attachment area not being parallel to each other.

4. The method according to claim 1, wherein the at least one second section comprises a functional element and/or a reinforcement element.

5. The method according to claim 1, wherein the method further comprises, to produce the at least one first section:
producing at least one metal block having a three-dimensional network of ribs which are complementary to ribs of a three-dimensional network of the at least one first section,
placing the at least one metal block in a mold at a location of the first section where the three-dimensional network is to be created, and
molding the first section of the part.

6. The method according to claim 1, wherein a material of the at least one first section of the part comprises one of polypropylene, polyamide, acrylonitrile butadiene styrene, polystyrene-b-poly(ethylene-butylene)-b-polystyrene, and a combination thereof.

7. The method according to claim 1, wherein a material of the at least one second section of the part comprises one of polypropylene, polyamide, acrylonitrile butadiene styrene, polystyrene-b-poly(ethylene-butylene)-b-polystyrene, and a combination thereof.

8. The method according to claim 1, wherein, before producing the second section by three-dimensional printing, the method comprises:
applying a surface treatment to the first section of the part.

9. The method according to claim 1, wherein the plastic material forms a bodywork part.
